(19) United States
(12) Patent Application Publication
(10) Pub. No.: US 2010/0223186 A1
(43) Pub. Date: Sep. 2, 2010

(54) Method and System for Conducting Secure Payments

(76) Inventors: Edward J. Hogan, New York, NY (US); Carl M. Campbell, Newtown Square, PA (US); John Wankmueller, Great Neck, NY (US); Gilles Garon, Toronto (CA)

Correspondence Address: BAKER BOTTS L.L.P., 30 ROCKEFELLER PLAZA, 44TH FLOOR, NEW YORK, NY, 10112-4498, US

(21) Appl. No.: 12/555,619

(22) Filed: Sep. 8, 2009

Related U.S. Application Data
(63) Continuation-in-part of application No. 11/943,062, filed on Nov. 20, 2007.
Application No. 11/943,062 is a division of application No. 09/833,049, filed on Apr. 11, 2001, now Pat. No. 7,379,919.
Application No. 09/833,049 is a continuation-in-part of application No. 10/507,867, filed on Mar. 24, 2005, now abandoned.
Application No. 10/507,867 is a continuation-in-part of application No. 09/809,367, filed on Mar. 15, 2001.
(60) Provisional application No. 60/195,963, filed on Apr. 11, 2000.
(60) Provisional application No. 60/365,737, filed on Mar. 19, 2002.

(51) Int. Cl. G06Q 20/00; G06Q 40/00; G06F 7/58

(52) U.S. Cl. 705/71; 705/75; 705/44; 708/250

(57) ABSTRACT

A proximity device transmits a first dynamic authentication value contactlessly to a terminal. The first authentication value is included in a discretionary data field of message data arranged in an ISO Track 1 and/or ISO Track 2 format. Message data is sent from the terminal to an issuer. The issuer separately derives a second authentication value and compares it with the first authentication value.

### RELATED APPLICATIONS

This application is a continuation-in-part of U.S. patent application Ser. No. 11/943,062, filed Nov. 20, 2007, which is a divisional of U.S. patent application Ser. No. 09/833,049 filed Apr. 11, 2001 which claims priority to U.S. Provisional Application 60/195,963, filed on Apr. 11, 2000, and entitled “Method and System for Conducting Secure Payments Over A Computer Network,” each of which are hereby incorporated by reference in their entireties, and to U.S. application Ser. No. 09/809,367, filed Mar. 15, 2001, and entitled “Method and System for Secure Payments Over A Computer Network,” which is also incorporated by reference in its entirety. This application is also a continuation-in-part of U.S. patent application Ser. No. 10/507,867, filed on Mar. 24, 2005, which is a national stage entry of PCT/US03/08377, filed on Mar. 19, 2009, and claims priority to U.S. Provisional Application 60/365,737 filed on Mar. 19, 2002, entitled “Proximity Chip Payment Specification,” each of which are also incorporated by reference in their entireties.

### BACKGROUND

This invention relates to a method and system for conducting secure financial transactions over a communications network and more particularly to a method and system for transmitting payments securely over a payment network, and for transmitting sensitive information securely over communication channels.

As is self-evident, on-line commerce has experienced tremendous growth over the last few years but even with that growth consumers are still troubled and concerned about using personal financial information and transmitting such information, such as credit card numbers and personal identification numbers, over public communications networks, such as the Internet. As a result, over the last few years, companies have struggled to find a way—the best way—to ensure the security of payments made over a computer network and to decrease the risk of theft or misuse of financial information.

For example, U.S. Pat. No. 5,883,810 entitled “Electronic Online Commerce Card With Transaction Proxy Number For Online Transactions” and assigned to Microsoft Corporation, is directed to a system which provides for each transaction a temporary transaction number and associates it with the permanent account number; the transaction number looks like a real credit card number and the customer uses that transaction number and submits it to the merchant as a proxy for the customer account number. In this matter, the customer does not have to transmit over a public network his or her real credit card number.

In the '810 patent, the merchant passes along the transaction number to the issuing institution, which in turn uses the transaction number as an index, accesses the real customer account number and processes the authorization, sending the authorization reply back to the merchant under the transaction number. As a result, risk is purportedly minimized not only because the customer only transmits a transaction number but also because the proxy number is good only for a single purchase—theft “would not greatly benefit a thief because it cannot be repeatedly used for other purchases or transactions.” Col. 2, lines 60-61.

There is a need to improve upon the prior art systems and in particular there is a need for a method and system for conducting a secure financial transaction over the Internet which avoids requiring the creation and transmission of a unique repeatedly generated transaction number to replace the transmission of the permanent account number for each conducted transaction.

According to the invention of co-pending application Ser. No. 09/809,367, filed Mar. 15, 2001, which is incorporated herein by reference, a “pseudo” account number is assigned to a customer and cryptographically linked to a consumer's payment account number. The payment account number is an account number issued by a financial institution or other organization that a consumer may use to make a payment for goods and/or services. For example, the payment account number may be the account number from a payment card, such as a credit or debit card, or from a payment application, such as an electronic cash application stored on a consumer's computer. The pseudo account number appears to be an actual payment account number to a merchant. That is, the pseudo account number has the same length as a valid payment account number and begins with a valid identification number (e.g., a “5” for MasterCard International Incorporated (“MasterCard”)). The pseudo account number is used by the customer instead of the real account number for all of his or her on-line financial transactions.

According to the invention of the co-pending application Ser. No. 09/809,367, all transactions based on pseudo account numbers are preferably cryptographically authenticated using a secret key that is unique for each account number. The authentication may be based on the private key of a public-key pair (“public-key authentication”), or based on a secret key other than a private key (“secret-key authentication”). Thus, if unauthorized persons were to ascertain any pseudo account numbers, they would be unable to make fraudulent transactions using them.

This system can still be improved upon and security can be further enhanced to protect the messages and information being transmitted during or in connection with a financial transaction being conducted over public communications lines.

Similarly, the security of card present payments can also be improved. Magnetic stripe payment cards store information in “tracks”—commonly denoted as “Track 1,” “Track 2,” and “Track 3”—on the magnetic stripe. When such payment cards are swiped through a card reader, data from the tracks is sent over a network to complete a transaction. Such cards typically also include an authentication value printed on the card and an authentication value (which is usually different from the printed value) stored in the magnetic stripe, both of which help to protect against fraud. On a typical MasterCard™ card, the authentication value stored in the magnetic stripe is called CVC1, and the printed authentication value is called CVC2. The printed authentication value does not get transferred to carbon copy paper when a magnetic stripe card is run through an imprinter to make a mechanical copy of the card. Because of this, a duplicate of the card cannot readily be made from the account information transferred to a sales slip (i.e., account number, cardholder name, and expiration date). For card-not-present transactions, such as telephone or internet purchases where a purchaser is not in the presence of a merchant, the printed value is especially useful to protect against fraud because typically, only the person in possession of the card can provide the printed value to the merchant.

When a transaction involving a magnetic stripe card is conducted using a terminal, the terminal reads the information stored on at least one of the tracks of the credit card. Currently, most terminals read Track 1 and/or Track 2 of the magnetic stripe. The tracks are formatted according to standards promulgated by the International Organization for Standardization (ISO). The relevant ISO standards specify the required data elements to be included on the tracks including, for example, the credit card holder's primary account number, a service or country code, the account holder's name, and a longitudinal redundancy check value. In addition to the foregoing specified data elements, the relevant ISO standards also reserve a data field for use at the discretion of the card issuer. This field is called the “discretionary data field.” Card issuers typically store an authentication value in the discretionary data field. On MasterCard cards, the CVC1 value is stored in a portion of the discretionary data field.

Unfortunately, the static nature of a conventional authentication value (whether printed or stored in the magnetic stripe) increases the risk of fraud, because if an unauthorized person obtains the account information and the printed authentication value, that person has all the information required to fabricate a duplicate card or to conduct a fraudulent transaction.

One approach to reducing the risk of fraud is to use smart cards or integrated circuit cards, which include internal processing functionality, to produce dynamic authentication values. To date, however, smart card technology has used digital signature schemes based on public key cryptography techniques. Such an approach is costly and inconvenient because it requires cards and terminals that must perform cryptographic functions and requires management of public keys. Furthermore, this approach requires the costly modification of and/or addition to the existing payment network infrastructure that currently exists, because the existing infrastructure has been designed for processing magnetic stripe payment cards and is not designed to accept and communicate the binary data associated with cryptographic techniques.

A need therefore exists for better, more cost-effective security for payment card transactions.

### SUMMARY

According to certain embodiments of the present invention, therefore, a method of conducting a transaction using a payment network is provided, in which a service provider receives a first authorization request for the authorization of a transaction using a first payment account number, wherein:
(i) the first payment account number has a BIN code associated with the service provider, and is associated with a second payment account number having a BIN code associated with an issuer of said second number;
(ii) the first authorization request includes an acquirer code associated with an acquirer; and
(iii) the first authorization request is routable through the payment network to the service provider based on the BIN code of the first payment account number.

The method further includes having the service provider respond to the first authorization request by transmitting a second authorization request for authorization of the transaction using the second payment account number, the second authorization request including an acquirer code associated with the service provider and being routable through the payment network to the issuer based on the BIN code of the second payment account number.

Additionally, a response to the second authorization request is received by the service provider from the issuer, where the response includes the acquirer code associated with the service provider and is routable through the payment network based on that code. A response to the first authorization request is then transmitted by the service provider to the acquirer based on the response to the second authorization request, and the response to the first authorization request preferably includes the acquirer code associated with the acquirer and is routable through the payment network based on that code.

Another embodiment of the invention includes a method of conducting a transaction with a merchant using a first payment account number that is associated with a second payment account number, where the method comprises: (a) generating a message authentication code based on one or more transaction details; (b) transmitting at least the first payment account number and the message authentication code to the merchant; (c) requesting by the merchant an authorization for payment of the transaction using the first payment account number, the request being formatted as if payment were tendered at a point-of-sale terminal with a conventional magnetic-stripe payment card, the message authentication code being transmitted in a discretionary data field contained in a track of the type used in the magnetic stripe of said conventional payment card; (d) responding to the authorization request for the first payment account number by requesting an authorization for payment of the transaction using the associated second payment account number; and (e) accepting or declining the authorization request for the first payment account number based on the response to the authorization request for the second payment account number and the message authentication code.

Another embodiment of the present invention addresses drawbacks of the prior art by using a dynamic authentication value—preferably generated cryptographically—which is placed in the discretionary data field of a an ISO standard track (preferably, Track 1 and/or Track 2) data field by a proximity device or by a terminal, and is transmitted from the terminal to the issuer of the card or other proximity device being used to conduct a transaction. Along with the dynamic authentication value, the discretionary data field also includes other data to be used by an issuer for verifying the transaction. Preferably, the dynamic authentication value is not the same as the static authentication printed on a magnetic stripe card, but instead, changes with each transaction. As a result, even if an unauthorized person obtains an authentication value used for a particular transaction, the unauthorized person could not use that authentication value for other transactions. Furthermore, because the authentication data is stored in an already-defined field of Track 1 and/or Track 2 in the specified binary coded decimal (BCD) format, the existing payment card network infrastructure can be used with little or no modification.

In accordance with one aspect of the present, a transaction is conducted using a proximity device by the following steps: dynamically generating a first authentication value; transmitting the first authentication value from the proximity device to a terminal; including the first authentication value in a discretionary data field of message data, the message data being arranged in an ISO format; and transmitting the message data from the terminal for verification. Preferably, the message is arranged in an ISO Track 1 or ISO Track 2 format.

In accordance with another aspect of the present invention, a transaction is conducted using a proximity device by the following steps: generating a random number; transmitting an authentication command contactlessly from the terminal to the proximity device, the authentication command including the random number; dynamically generating first authentication value using a first authentication key by the proximity device to derive the first authentication value from data comprising at least the random number; transmitting the first authentication value from the proximity device to a terminal; including the first authentication value in a discretionary data field of message data, the message data being arranged in a format including at least one of an ISO Track 1 and an ISO Track 2 format; transmitting the message data from the terminal to an issuer; calculating a second authentication value by an issuer using a second authentication key and the message data; and comparing the second authentication value to the first authentication value by the issuer.

### BRIEF DESCRIPTION OF THE DRAWINGS

Further objects, features and advantages of the invention will become apparent from the following detailed description taken in conjunction with the accompanying figures showing embodiments of the invention, on which:

FIG. 1 is a block diagram of the system for obtaining a secure payment application from a provider over the Internet in accordance with the invention;

FIG. 2 is a flow diagram illustrating the flow of information between a cardholder and a merchant when conducting a secure payment over the Internet using the present invention;

FIG. 3 is a flow diagram illustrating the flow of information between an acquirer, a service provider and an issuer, in accordance with the present invention;

FIG. 4 is a flow diagram illustrating the flow of information between an issuer, a service provider and an acquirer, in accordance with the present invention;

FIG. 5 is a flow diagram illustrating the flow of communication between a merchant and an acquirer for purposes of settlement and clearing, in accordance with the present invention;

FIG. 6 is a diagram of the interacting components of a system for conducting a transaction using a dynamic authentication value in a discretionary data field according to a preferred embodiment of the present invention;

FIG. 7 is a diagram illustrating an exemplary layout of data arranged in a Track 1 format;

FIG. 8 is a diagram illustrating an exemplary layout of data arranged in a Track 2 format;

FIG. 9 is a diagram illustrating a layout of the discretionary data field of FIG. 2 in one exemplary embodiment of the present invention;

FIG. 10 is a diagram illustrating a layout of the discretionary data field of FIG. 3 in one exemplary embodiment of the present invention;

FIG. 11 is a flow diagram illustrating a exemplary process whereby a transaction is conducted between a proximity device and an issuer;

FIG. 12 is a flow diagram illustrating a exemplary process whereby an authentication value is calculated by a proximity chip;

FIG. 13 is a flow diagram illustrating a exemplary process whereby a proximity device is verified by an issuer;

FIG. 14 is a diagram illustrating an exemplary computer system for performing the procedures illustrated in FIGS. 1-8; and

FIG. 15 is a block diagram illustrating an exemplary processing section for use in the computer system illustrated in FIG. 14.

Throughout the figures, the same reference numerals and characters, unless otherwise stated, are used to denote like features, elements, components or portions of the illustrated embodiment. Moreover, while the subject invention will now be described in detail with reference to the figures, it is done so in connection with a preferred embodiment. It is intended that changes and modifications can be made to the described embodiment without departing from the true scope and spirit of the subject invention as defined by the appended claims.

### DETAILED DESCRIPTION

### Initialization of the Secure Payment Application

In accordance with one embodiment of the invention, a service provider issues, maintains and/or processes several components, including a secure payment application (“SPA”), of the secure payment system to be conducted in accordance with the techniques of the present invention.

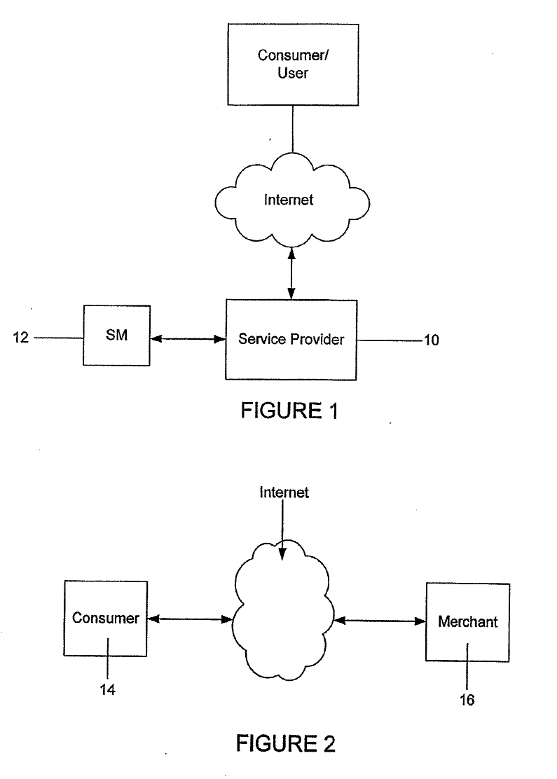

FIG. 1 illustrates first how a cardholder with a financial transaction card may obtain a secure payment application from the service provider 10 over the Internet, according to an exemplary embodiment of the present invention. It should initially be understood that a physical card is not necessary to utilize and obtain the benefits of the invention, but that only an account number be issued to a holder (in this case a cardholder) which identifies and links a user or participant to an account for purposes of conducting a financial transaction. The cardholder may contact a web server associated with the service provider using any appropriate device that may communicate over the Internet, such as a computer, cellular phone, or a personal digital assistant (PDA). For the purpose of simplicity in the following discussions, it is assumed that the cardholder uses a computer to communicate over the Internet.

As shown in FIG. 1, the service provider, for example MasterCard International Incorporated (or an agent of MasterCard), has in its control one or more physically secure security modules 12, which offer physical protection for the information stored inside the modules. These security modules each contain one or more “derivation keys” that are used to create and re-create account-unique secret cryptographic keys, as explained below, which are provided within the secure payment application.

First, in accordance with one embodiment of the invention, the cardholder must obtain an SPA from the service provider. The preferable steps for downloading and initializing the secure payment application (SPA) include:
1. The cardholder contacts the service provider's web site via the Internet (either directly or through a hyperlink to the web site through another web site, such as an issuer's web site.
2. The cardholder provides, under SSL encryption generally known to those skilled in the art, (a) a payment card account number, (b) a card expiration date, and (c) card authenticating information. The card authenticating information may include, for example, the card's CVC2 value, which refers to a three or four digit value that is printed next to the signature panel of some cards. This value is generated by the issuing bank using a secret cryptographic key and can be verified using this same key.
3. The service provider may confirm the legitimacy of the card account number and the card expiration date by obtaining a zero amount authorization from the issuer of the cardholder's payment card. For instance, MasterCard may obtain this authorization over its Banknet™ communications network.
4. The service provider may verify the CVC2 value if the issuer of the cardholder's payment card has provided the service provider with the cryptographic key(s) for verifying the CVC2 value.
5. The service provider may verify other card authenticating information by sending such information to the issuer for verification.
6. After the service provider (“SP”) has confirmed the legitimacy of the cardholder-provided card data, the SP creates or selects a pseudo account number and a secret key and embeds these data elements into a secure payment software application that is made available to the cardholder for download over the Internet preferably under SSL encryption.

The pseudo account number has as its BIN a special BIN reserved for pseudo account numbers. The remainder of the pseudo account number is a value that can be translated by the service provider via a table look-up process to the “real” account number.

Preferably, the assigned special service provider BIN may be one from a set of many such special BINS, where each BIN may correspond to a particular country or region and/or to a particular product within a country or region. Thus, the assigned special BIN may be the one that corresponds to the country and/or the product of the submitted “real” account number.

The secret key that the service provides preferably embeds in an SPA is unique for each card account number and is preferably derived within a security module using the card account number and a derivation key. This derivation key may itself be derived within the same or another security module using a higher-level derivation key.

The cardholder may provide a password to the service provider prior to downloading the secure payment application or may select a password when the secure payment application is being installed on the cardholder's computer. If a password is provided or selected, the cardholder will thereafter be required to enter this password in order to activate the secure payment application. The password selected by the cardholder may be used to encrypt the secret key included in the SPA.

As would be recognized by those skilled in the art, the SPA may be downloaded as part of a digital wallet application. In addition to the SPA, the digital wallet may store a cardholder's personal information and other applications, such as a purse application.

### Generating Card-Unique Secret Keys

The following steps may preferably be performed within a security module 12 controlled by the service provider or one of its agents to obtain a card-unique secret key to be included in the secure payment application. The following steps assume that the cardholder's payment card has a 16-digit account number and that the Data Encryption Algorithm (DEA) known to those skilled in the art, with a double-length key is used. The DEA is a U.S. Government standard cryptographic algorithm that is described in Federal Information Processing Standard (FIPS) 46-1, which is incorporated herein by reference in its entirety. The DEA is also defined in the ANSI standard X9.32, which is also incorporated herein by reference in its entirety.

It is also assumed that the security module holds a secret high-level key called the derivation key that consists of 16 bytes and is used with many or all card account numbers to cryptographically compute a card-unique secret key, called the Per-Card Key, given the cardholder's 16-digit payment account number. The derivation key may be unique for each country or for each special bank identification number or BIN.

Preferably, the steps are:
1. Considering the payment account number as 16 binary-coded-decimal digits of 4 bits each, DEA-encrypt these 64 bits using as the encryption key the left-most 8 bytes of the 16-byte Derivation Key.
2. DEA-decrypt the result of Step 1 using as the decryption key the right-most 8 bytes of the 16-byte Derivation Key.
3. DEA-encrypt the result of Step 2 using as the encryption key (again) the left-most 8 bytes of the 16-byte Derivation Key.
4. Use the result of Step 3 as the left-most 8 bytes of the unique Per-Card Key.
5. DEA-encrypt the result of Step 3 using as the encryption key the left-most 8 bytes of the 16-byte Derivation Key.
6. DEA-decrypt the result of Step 5 using as the decryption key the right-most 8 bytes of the 16-byte Derivation Key.
7. DEA-encrypt the result of Step 6 using as the encryption key (again) the left-most 8 bytes of the 16-byte Derivation Key.
8. Use the result of Step 7 as the right-most 8 bytes of the 16-byte unique Per-Card Key, and place this key in the secure payment application in such a way that it will not be disclosed during the normal operation of this application.

### Communication Between Cardholder and Merchant

FIG. 2 illustrates the flow of information between the cardholder 14 and merchant 16 when conducting a secure payment over the Internet according to an exemplary embodiment of the present invention.

Once the SPA has been installed on a cardholder's computer, the cardholder preferably uses the SPA for all Internet payments and the SPA provides the cardholder's pseudo account number for all Internet transactions.

Once a cardholder has indicated a desire to conduct a transaction, it is desirable (but not essential) that the merchant pass to the cardholder's computer the following data elements: (1) the acquirer BIN, (2) the MID (the merchant identifier as known to the acquirer), and (3) the date and time (GMT or equivalent) of the transaction.

Preferably, the SPA uses its embedded, secret key to create a Message Authentication Code (MAC) relating to the transaction. For example, a MAC of approximately 8 decimal digits may be created on the following data elements:
1. A transaction sequence number stored in the cardholder's SPA and incremented by the SPA whenever it generates a MAC. This transaction sequence number may be, for example, six (6) decimal-digits in length.
2. The acquirer BIN if received from the merchant, otherwise zeros (which may be, for example, 6 decimal digits).
3. The MID if received from the merchant, otherwise zeros (which may be, for example, 6 decimal digits).
4. Date and time, to the nearest hour or minute (in GMT), if received from the merchant, otherwise zeros (which may be, for example, 10 decimal digits).
5. The transaction amount, as displayed for the cardholder, and as normally included in the message from cardholder to merchant (which may be, for example, 8 decimal digits).

Preferably, a merchant is able to accept a full Track-1 image from the cardholder's computer, just as if the merchant were prepared to communicate with computers that include magnetic-stripe readers. (The Track-1 image refers to the data on track 1 of the magnetic stripe of a payment card.) Moreover, the merchant preferably is able to pass the Track-1 data to the acquirer as if the transaction were a point-of-sale (POS) transaction.

If the merchant can accept the full Track-1 data, the MAC itself and the data elements upon which the MAC is based are placed in the Track-1 discretionary-data field. The pseudo account number is placed in the Track-1 account-number field, and the card expiration date is placed in the Track-1 expiration-date field.

By sending the MAC in the Track-1 discretionary-data field, many merchants will not need to make any changes to their systems and/or software because they can already handle POS transactions, which include Track-1 discretionary data. For other merchants, systems and/or software to handle POS transactions are readily available.

If a merchant cannot accept the full Track-1 data, the SPA may send a conventional SSL payment message, except that the pseudo account number is used instead of the cardholder's “real” account number. The merchant then sends the transaction data to the acquirer in the manner that it normally does. In practice, during a transition period, the merchants that are not capable of handling POS transactions with Track-1 data might not be required to receive and handle MACs.

Instead of being sent in the Track-1 discretionary-data field, the MAC may also be sent in another format, in which case merchants and acquirers may be required to change their systems and/or software to handle this other format.

Upon receipt of the cardholder's transaction message, the merchant formats a conventional authorization request for the acquirer. For those merchants that are able to able to accept Track-1 data, this authorization request will be formatted exactly as if it originated from a POS terminal and will include the Track-1 data provided by the cardholder.

Should a merchant initiate multiple authorization/clearing transactions for a cardholder transaction, preferably only the first of these transactions will include the Track-1 data. The subsequent transactions will include only the pseudo account number and expiration date and may be considered mail-order-telephone-order transactions. This is true for all recurring payments and partial payments with multiple clearings.

### Acquirer Handling of Authorization Request

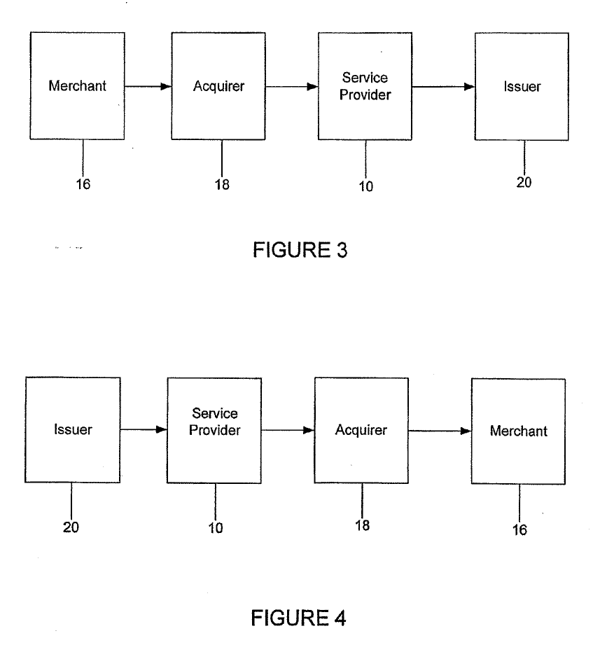

FIG. 3 illustrates the communication between an acquirer 18, service provider 10, and an issuer according to an exemplary embodiment of the present invention.

The presence of Track-1 data in an Internet transaction should not adversely impact those acquirers who receive transactions from Internet merchants via conventional telephone lines, since such transactions will be formatted identically to transactions from conventional point-of-sale terminals. However, acquirers who receive transactions via the Internet (and not conventional telephone) may need a “conversion box” that would deliver transactions without Track-1 data unchanged and would deliver transactions with Track-1 data over a different physical wire as if they had come from POS terminals. The design of such a conversion box is well within the ability of a person of ordinary skill in the art.

When an acquirer 18 receives an authorization request message from an Internet merchant 16, it looks up the issuer BIN in its BIN table. In the case of a pseudo account number transaction, the “issuer” will correspond to a service provider-authorized processing facility 10, which will receive the request. In the case of a non-pseudo or real account number, normal processing will take place.

Some countries may have a special security-module-equipped facility that handles domestic transactions. Each such domestic facility would preferably be set up only with the service provider's approval and would hold only the cryptographic keys and account-number conversion data for the country whose transactions it processes. In countries with such a domestic facility, all same-country transactions will be sent to this facility. This can also be done for individual banks in a country, if it is so desired.

A domestic facility to handle domestic transactions would be far more efficient than causing domestic transactions to go through a central processing facility.

### Service Provider Handling of the Authorization Request

When the service provider receives the request, it determines from the issuer BIN whether the account number is really a pseudo account number and, if so, sends the transaction to a special system for processing. This system translates the pseudo account number to the “real” account number using a table-lookup procedure. If the system determines that a Track-1 image is included, it uses a security module to derive the appropriate Per Card Key for this card account number in order to verify the MAC. (The derivation of the Per Card Key is described above.)

If the MAC is verified, the system then examines the BIN in the Track-1 discretionary-data area. If this is not all zeros, the system compares this BIN with the acquirer BIN of the transaction, and verifies that the date and time included in the Track-1 discretionary-data area are reasonable (taking into consideration that the merchant may batch its transactions and obtain delayed authorizations). The system also verifies that the authorization request amount does not exceed the transaction amount in the Track-1 discretionary-data area (the amount as approved by the cardholder) by more than a specified amount (e.g., 20%).

It is possible that an acquirer may include the MID in the Acquirer Reference Data (which is also called the Acquirer Reference Number). It is assumed that the 23-digit Acquirer Reference Data includes a mandatory “transaction type” indicator and a mandatory acquirer BIN, but that the remaining digits are for the acquirer's discretionary use and may in some cases include the MID. The service provider may obtain from its Internet acquirers an indication of which acquirers include the MID in the Acquirer Reference Data, and if so, where in the Acquirer Reference Data they include it. In the case of such an acquirer, if the Track-1 image includes an acquirer BIN (rather than six zeros), the service provider system may also verify that the MID in the Track-1 discretionary-data area matches the MID in the Acquirer Reference Data.

The service provider system may store a history of transaction sequence numbers (TSNs) for comparison with transaction sequence numbers in authorization requests. The comparison may be triggered by some condition, such as when the Track-1 amount exceeds some specified threshold (e.g., $200). Such a threshold may be lower when the Track-1 image does not include an acquirer BIN. When the comparison is triggered, the system may compare the transaction sequence number included in the Track-1 discretionary-data area against the stored history of transaction sequence numbers for the relevant card account number. If the transaction sequence number of the current transaction is 1) higher than the smallest stored value for the current account number and 2) does not match any stored value for this account, there is a reasonable assurance that the current transaction is not the fraudulent replay of data from a previous legitimate transaction.

The stored history of TSNs may be limited to a predetermined number of TSNs. For example, the system might store only the last 10 transaction sequence numbers received for a particular card account number. In addition, the verification of transaction sequence numbers need not occur in real time. It may occur while the system is obtaining an authorization from an issuer.

The purpose of these checks is to make it very difficult for wrongdoers who operate in collusion with Internet merchants and who may be able to obtain unencrypted transaction data to fraudulently replay data from legitimate transactions.

Once the service provider system has completed the above-described verification processes (with the possible exception of the transaction sequence number verification), the system formats an authorization request message for the issuer 20. This message includes the “real” account number and expiration date, but excludes the other Track-1 data. The system replaces the acquirer BIN with one of the special BINs that serves as a “pseudo” acquirer BIN. The acquirer BIN is replaced so that the issuer responds to the service provider instead of the acquirer.

In order for the acquirer and issuer to compute interchange fees correctly, the pseudo acquirer BIN should preferably correspond to the country in which the acquirer is located or to another country or region that will provide the same resultant interchange fees. If each country has a special BIN associated with it, the service provider may replace the acquirer BIN with the special BIN associated with the acquirer's country. If an acquirer's country does not have a special BIN associated with it, a special BIN associated with another country may be selected that results in the same interchange fees.

The service provider stores in a database the Acquirer Reference Data received in the authorization request from the acquirer (hereinafter referred to as the “original Acquirer Reference Data”). In formatting an authorization message for the issuer, the service provider preferably replaces the original Acquirer Reference Data with “pseudo” Acquirer Reference Data that includes the pseudo acquirer BIN, an appropriate transaction-type indicator, and an index value that the service provider can use to find the original Acquirer Reference Data.

When a domestic facility processes a pseudo-account-number transaction, it operates as described above. Preferably, however, this domestic facility will process only transactions for domestic issuers, and therefore will need only the cryptographic keys and account-number conversion table entries that apply to that country.

### Issuer Handling of Authorization Request

FIG. 4 illustrates the communication between the issuer 20, the service provider 10, and an acquirer 18 according to an exemplary embodiment of the present invention after the issuer has received an authorization request from the service provider or from an authorized domestic processing facility.

The issuer 20 authorizes the transaction just as it would any other transaction. It sends the authorization response back to the “pseudo” acquirer BIN, which will be either a service provider facility or a facility authorized by a service provider.

When the service provider 10 receives an authorization response from an issuer, it examines the acquirer BIN to determine whether it is a “pseudo” acquirer BIN. If so, the service provider determines that the authorization response corresponds to a pseudo account number transaction that must be “restored” to its original format. Thus, the service provider translates the “real” account number back to the pseudo account number, and restores the Acquirer Reference Data that had been in the original transaction. The service provider then transmits the resulting message to the “real” acquirer, which processes the transaction normally and sends the authorization response to the merchant in the normal way. The merchant responds to the authorization response as it would for any other transaction.

### Settlement and Clearing

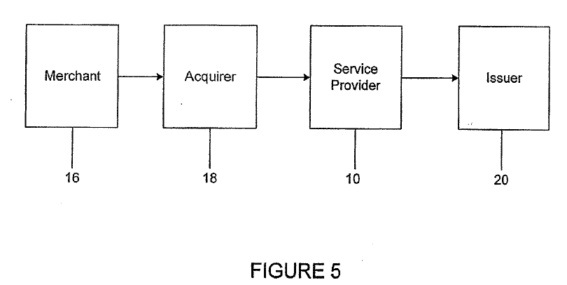

FIG. 5 illustrates the flow of communication between a merchant 16, an acquirer, service provider or payment processor, for example, MasterCard's Banknet, and an issuer for the purpose of settlement and clearing according to an exemplary embodiment of the present invention.

A clearing message is processed essentially in the same manner as an authorization request message. As previously described, the acquirer 18 (because of entries in its BIN table) automatically routes a clearing message using a pseudo account number preferably to the service provider 10 or payment processor. At this facility, the pseudo account number is replaced by the “real” account number, the acquirer BIN is replaced by the “pseudo” acquirer BIN, and the remainder of the Acquirer Reference Data is replaced by an index that the service provider can subsequently use to obtain the original Acquirer Reference Data. The clearing message with these changes is transmitted to the “real” card issuer 20, which processes the transaction in the normal way. If the acquirer happens to also be the issuer, the service provider returns the cleared transaction to the acquirer with the real account number and proper fee calculations.

### Exception Processing

When a message about a transaction must be transmitted back to the acquirer or merchant from an issuer, the message is processed by the issuer as it normally would process any transaction message. Since the transaction as known to the issuer includes the “pseudo” acquirer BIN, the “pseudo” acquirer BIN will cause the transaction message to be routed to a service provider facility. At this facility the “real” account number is replaced by the pseudo account number, and the pseudo Acquirer Reference Data is replaced with the original Acquirer Reference Data. The transaction message is then routed to the acquirer, which processes it like any other such transaction message.

### Issuance of Plastic Cards for Identification

In some situations, a cardholder may buy a ticket over the Internet and will be required, upon showing up at the event to which the ticket grants admission, to produce the card used in the transaction in order to authenticate rightful possession of the ticket.

To accommodate such situations, the service provider may issue and mail physical plastic cards to cardholders who obtain pseudo account numbers for Internet use. These cards would clearly indicate “for identification purposes only, not valid for transactions” on them. The embossed and encoded account number would be the pseudo account number, though the CVC2 may be that of the “real” payment card.

As another alternative, those merchants that have a legitimate need to authenticate a cardholder using a pseudo account number may register with the service provider (by providing to the service provider appropriate identification and authentication information), and the merchants will be provided with a secret key or certificate as cryptographic proof of their registration. Thereafter, such merchants may obtain “real” account numbers from a service provider facility by providing a copy of the pseudo-account-number transaction details under cryptographic authentication that authenticates both the transaction data and the merchants' right to obtain a “real” account number. The service provider may then forward the “real” account numbers in encrypted form to the merchants, so that the cardholders may be identified with the cards corresponding to their “real” account numbers.

### Proximity Payment Dynamic Value Generation

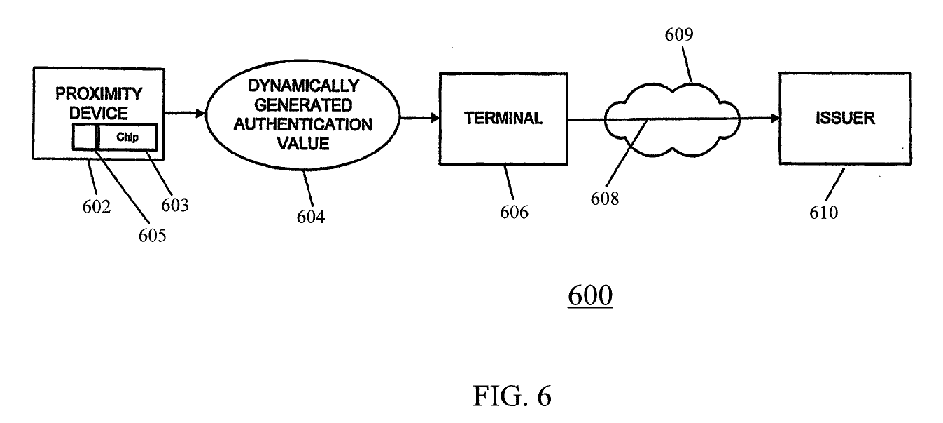

FIG. 6 depicts an exemplary system for conducting transactions according to a preferred embodiment of the present invention. The illustrated system includes an IC card or proximity device 602 which in one embodiment includes a proximity chip 603 and contactless communication interface circuitry 605. The proximity device 602 can be in the form of a credit card and can include a magnetic stripe. The proximity device 602 can also take other forms, such as a key fob, and/or can be incorporated into a mobile phone or a watch. The proximity device 602 generates and transmits a dynamically generated authentication value 604 to a terminal 606. The authentication value is typically transmitted via an RF (radio frequency) signal. The authentication value is formatted in a discretionary data field 608 of Track 1 and/or Track 2 and transmitted to an issuer 610, typically through a computer network 609. The formatting can take place in either the proximity device 602 or in the terminal 606.

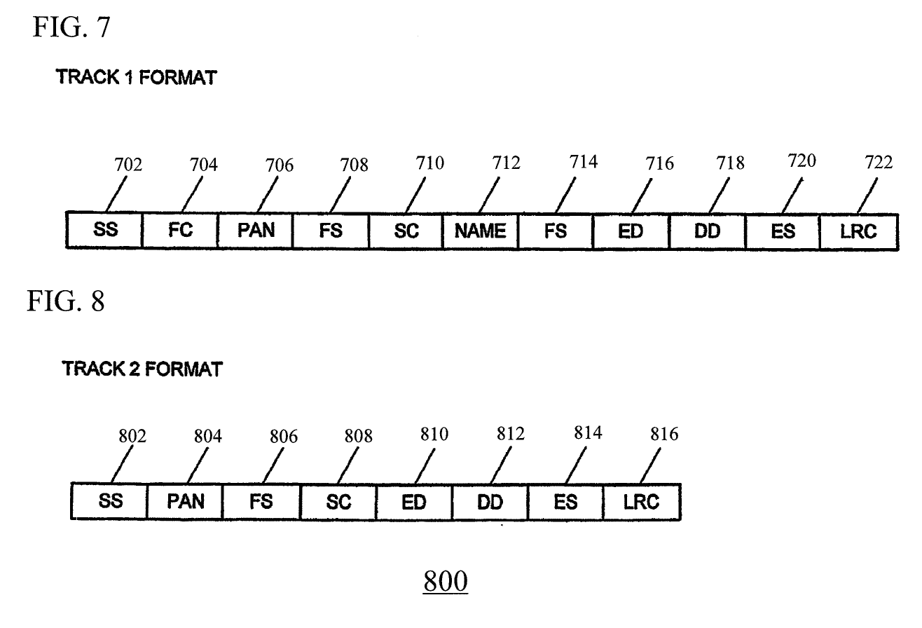

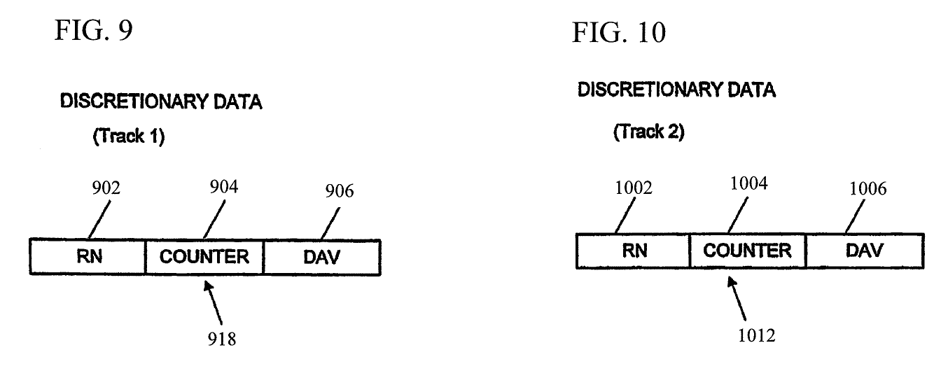

The layout of exemplary data arranged in ISO Track 1 format is illustrated in FIG. 7. The Track 1 layout includes a start sentinel 702, followed by a format code 704, followed by a primary account number 706, followed by a field separator 708, followed by a service code 710, followed by the name of the account holder 712, followed by a field separator 714, followed by an expiry date 216, followed by discretionary data 718, followed by an end sentinel 720, and finally by a longitudinal redundancy check 722. The discretionary data 718 can include a random number 902, a counter value 904, and a dynamic authentication value 906, as depicted in FIG. 9.

The layout of exemplary data arranged in ISO Track 2 format is illustrated in FIG. 8. The Track 2 layout includes a start sentinel 802, followed by a primary account number 804, followed by a field separator 806, followed by a service code 808, followed by an expiry date 810, followed by discretionary data 812, followed by an end sentinel 814, and finally by a longitudinal redundancy check 816. The discretionary data 812 can include a random number 1002, a counter 1004, and a dynamic authentication value 1006, as depicted in FIG. 10.

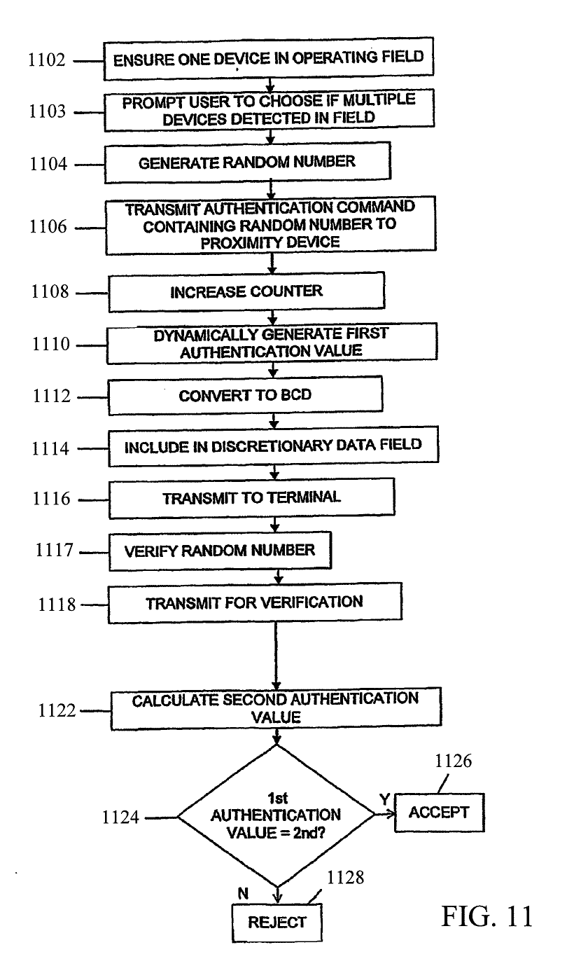

FIG. 11 illustrates an exemplary procedure for conducting a transaction using the system illustrated in FIG. 6. Optionally, the terminal 606 can check to ensure that only one proximity device 602 is within its operating field (step 1102). If more than one proximity device 602 is within the operating field, the terminal can prompt the user to choose which proximity device is to be used (step 1103). In any case, the terminal 606 or the issuer 610 or the proximity device 602 generates a random number (step 1104). The random number can be generated, for example, by a conventional random number generation algorithm or by a hardwired random number generator, and can be in BCD or hexadecimal (HEX) format. Such random number generation algorithms and hardwired random number generators are well known in the art. Alternatively, or in addition, the random number might be data regarding the transaction, such as a transaction time, amount, or merchant identifier. The terminal 606 transmits an authentication command to the proximity device 602 (step 1106). The proximity device 602 contains a proximity chip 603, which maintains a counter and increases the counter each time an authentication command is received (step 1108). The counter can be in BCD or HEX or binary format. The proximity chip 603 within the proximity device 602 derives a first authentication value using a first authentication key from the random number received (step 1110). If a DES (Data Encryption Standard) security infrastructure is being used, the first authentication key is preferably a secret key which is shared with the issuer. If a Public Key Infrastructure (PKI) is being used, the first authentication key is preferably a private key associated with the particular proximity device. In any case, the first authentication key can be stored, for example, in the memory of the proximity chip 603. Contactless communication interface circuitry 605 can be included as part of the proximity chip 603, or it can be separate from the chip. The proximity device 602 includes the first authentication value in a set of message data—optionally, in the discretionary data field of Track 1 and/or Track 2 message data—(step 1114) and transmits the message data contactlessly to the terminal 606 (step 1116) via the contactless interface 605. The message data also includes the random number and a counter value maintained by the proximity chip 603, or representations thereof. Preferably, the random number or representation thereof in the message data is verified (step 1117) at the terminal 606 by comparing it with the random number previously transmitted to the device 602 (if the terminal generated and/or transmitted the random data). The representation of the random number can be, for example, the final 3 digits of a longer number previously transmitted to the device. If the first authentication value was not formatted (in step 1114) by the proximity device 602 as part of the discretionary data field of Track 1 and/or Track 2 message data, this formatting can be performed by the terminal 606, or by an agent of an issuer 110. The agent can be an issuer application running on a user's computer—e.g. a PC with proximity device reader. In any case, the terminal 606 or the proximity device 602 converts remaining data in HEX or binary format into BCD (step 1117). The terminal 606 transmits the data arranged in a Track 2 format 104 for verification (step 1118). Verification is typically performed by an issuer 610. Using a second authentication key, —which if DES security is being used is presumably the same key as the first authentication key stored in the proximity device 602—the issuer 610 calculates a second authentication value using message data received from the proximity device via the terminal (step 1122). If PKI is being used, the second authentication key is presumably the public key associated with the private key of the proximity device. To verify the transaction, the issuer 610 compares the first authentication value with the second authentication value (step 1124) and either accepts (step 1126) or rejects (step 1128) the transaction depending on whether the values match.

The proximity device 602 preferably supports various features, such as an authentication key, a secure messaging key to write to memory areas that are protected, and a manufacturer cryptographic key. The manufacturer cryptographic key allows an issuer to securely load the authentication key, the secure messaging key, and payment related data. Single and double length cryptographic keys should be also supported. The proximity device 602 preferably protects data written to the device memory against deletion or modification, and prohibits the external reading of memory locations containing a cryptographic key. The proximity device 602 should also maintain a binary counter, preferably having at least 15 bits, and should increase the counter (step 1108) every time the authenticate command is presented (step 1106) to the device 102. The device 602 can implement ISO communication interface Type A, Type B, or both. These well-known interface types are described in ISO/IEC 14443 parts 1-4, which are incorporated herein by reference.

Preferably, the terminal 606 is configured to be capable of reading a magnetic stripe card as well as a proximity device 602. For a device containing both a magnetic stripe and a proximity chip 603, the terminal 606 should first try to perform the transaction using the proximity chip reader, and should use the magnetic stripe if there is an error in communicating with the chip.

At least two commands are typically used to send data from the terminal 606 to the proximity device 602, a select command and an authenticate command. Other commands can also be used, such as the well-known Europay Mastercard Visa (EMV) “get processing options” command. The select command is used to select a proximity chip payment application. The authenticate command initiates computation of the dynamic authentication code within the proximity device. The response to the authenticate command from the device 602 can contain Track 2 formatted data, the device serial number, and transaction flags.

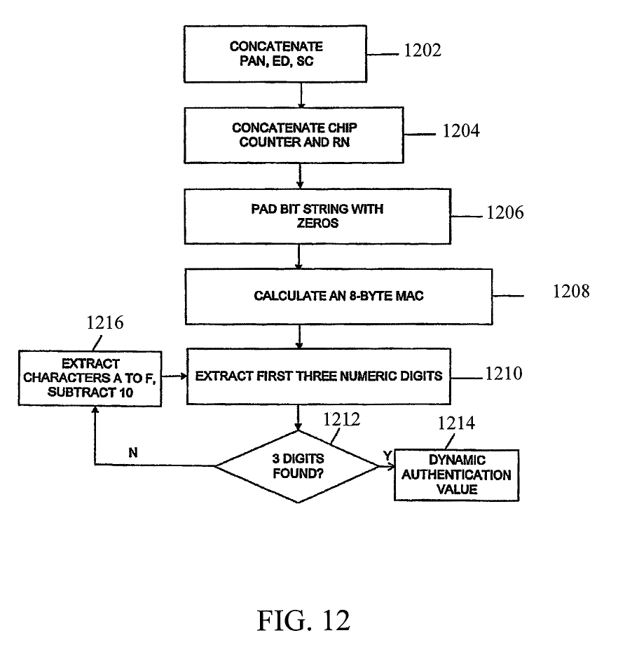

The preferred method of calculating the dynamic authentication value is the well known DES technique. The proximity device 602 preferably calculates the dynamic authentication by the following steps, as depicted in FIG. 12. First, a string of bits is constructed by concatenating, from left to right, the four rightmost bits of each character of the primary account number (up to 16×4=64 bits), the expiry date (4×4=16 bits), and the service code (3×4=12 bits) (step 702). Also concatenated to the bit string are the device proximity chip counter (15 bits) and the 5-digit random number (5×4=20 bits) generated by the terminal 606 (step 1204). The bit string is padded with binary zeros to a multiple of 64 bits (typically, to a total of 128 bits) (step 1206). For example, the Track 2 “discretionary data” field 312 is 13 BCD when the primary account number is 16 BCD and the DES calculation of the discretionary data field 812 uses all 13 BCD. When the primary account number is less than 16 BCD, the issuer can increase the size of the dynamic authentication value field 1006 in the discretionary data field 812 beyond 3 BCD digits. Next, an 8-byte MAC (Message Authentication Code) is calculated using the proximity chip secret authentication key (single or double length) (step 1208). The first 3 numeric digits (0-9) from left to right are extracted from the HEX result of the second step above (step 1210). If less than 3 digits are found (step 1212), characters A to F from left to right are extracted from the result of step 1208 and 10 is subtracted to compensate for decimals, until 3 digits are found (step 1216). The first three digits found are used as the dynamic authentication value (step 1214).

Preferably, the proximity chip 603 converts the proximity chip counter (15-bit) to BCD using the following steps. First, the chip selects the leftmost 3 bits of the counter, adds a zero bit to the left, and converts the result to BCD. Next, the chip selects the next 3 bits of the counter, adds a zero bit to the left and converts the result to BCD. The chip performs the second step an additional 3 times to translate the 15 bit counter to 5 BCD characters. If the above described procedure is used for converting the counter to BCD, each BCD digit will range from 0 to 7. This procedure is beneficial for simplifying the implementation of the hardware and/or software required to convert to BCD in a reduced functionality proximity device. Alternately the counter in the proximity chip 603 can itself be in BCD format, in which case the same format is preferably used in the issuer host system. A BCD-encoded counter makes it possible to increase the size of the maximum counter value to 99,999 in the chip using decimal counting (5 BCD characters, 4 bits per character using only BCD 0-9 characters), although this typically requires more processing logic in the chip.

In this embodiment, the proximity device 602 inserts into the discretionary data field 812 of Track 2 with the random number (5 BCD) field 1002, the proximity chip counter (5 BCD) field 1004, and the dynamic authentication value (3 or more BCD) field 1006. Truncation may first be required to fit this data into the discretionary data field. If so, the least significant digits are generally used. The proximity device 102 returns the Track 2 data to the terminal 606 in the response to the authenticate command (step 1116). The Track 2 data (maximum 19 ‘8 bit’ binary bytes) may be TLV (Tag Length Value) coded (Tag=“57”). The Track 2 data is assembled as follows, using 4-bit BCD values. A start sentinel is followed by the primary account number (up to 16 BCD). This is followed by a field separator, which may be Hex. ‘D’. This is followed by an expiration date, which may be 4 BCD in the format of YYMM. This can be followed by a service code (3 BCD). This may be followed by the dynamic discretionary data (13 or more BCD). The discretionary data can include the random number (5 BCD), followed by the proximity chip counter (5 BCD), followed by the dynamic authentication value. The dynamic authentication value may be 3 BCD when account number is 16 digits, but it can be greater than 3 BCD if account number is less than 16 digits. The discretionary data may be followed by an end sentinel and a longitudinal redundancy check. Thus, while the discretionary data field used on a traditional magnetic stripe card merely contains enough characters to fill out the maximum record length of Track 2 (40 characters total) and is generally not verified during a transaction, the discretionary data field used with a proximity device in the illustrated example contains a dynamic authentication value in the discretionary data of Track 2 used for authentication of the device.

Some proximity chip manufacturers may not be able to produce a reduced functionality device that supports a DES algorithm. In such cases, a proprietary method can be used to calculate the device dynamic authentication value. Preferably, such a proprietary method should have the following features. A proven proprietary cryptographic algorithm should be used. The proximity chip counter should have a minimum of 15 bits in length. The random number should be 5 digits (5 BCD). The primary account number, the expiry date, the service code, the proximity chip counter, and the random number should be included in the calculation of the dynamic authentication value. The dynamic authentication value should have a minimum of 3 BCD characters. The proximity device 602 should be able to replace the Track 2 discretionary data 806 with the random number, the proximity chip counter, and dynamic authentication value (minimum 3 BCD). The device 602 should return the whole Track 2 data, the proximity device serial number and proximity device transaction flags and other device data. The random number, the proximity device proximity chip counter, and proximity device generated dynamic authentication value should fit in the discretionary data field 812 of the Track 2 data sent to a terminal 606.

Although the preferred method of calculating the dynamic authentication value is the DES method, PKI can also be used.

Each proximity chip authentication key is preferably unique and is preferably derived from a Master Derivation Key protected by the issuer. The Master Derivation Key should be a double length key. Derivation of proximity chip keys should preferably be done in a secure cryptographic device. The encryption function preferably uses the primary account number and the master derivation key to derive the proximity chip authentication key. When a double length proximity chip authentication key is used, the second part of the key should be derived by complementing each bit of the primary account number (1 bits changed to 0, 0 bits changed to 1) before the encryption process.

Even if the issuer uses a proprietary authentication method, the key derivation process should still be similar to the method described above. The device authentication key preferably has a minimum of 48 bits (64 for DES). The bit size doubles for a double length device key.

Upon receipt of an authorization request, the issuer performs the following steps. The issuer determines if the request originates from a proximity device 602, in order to initiate processing specific to proximity devices (step 1302). The issuer can do this by a decoding data element (61 position 10) which the terminal would set to a value of ‘7’ to indicate that the request originated from a proximity device that the terminal has read. Alternately, or in addition, the issuer can list into the cardholder database the primary account numbers assigned to the proximity device 602. The issuer host system should, for each proximity device 102, keep track of the proximity chip counter and verify that the proximity chip counter received is the next sequential number (step 1304). Verification of the proximity chip counter can be used to prevent transaction replay. Repeated counter values can also indicate that previously used proximity chip Track 2 data has been fraudulently obtained and is now being used by an unauthorized person. Using a proximity chip authentication key, the issuer calculates the proximity device dynamic authentication value as described above using the primary account number, expiry date, service code from the received Track 2, and the authentication data (proximity chip counter, random number) in the Track 2 discretionary field (step 1308). The issuer compares the calculated dynamic authentication value to the one in the proximity device Track 2 discretionary data field (step 1310) and either accepts (step 1312) or rejects (1314) the transaction. The issuer can process the authorization as a magnetic stripe authorization when the dynamic authentication value is successfully verified.

Derivation of proximity chip keys and verification of the dynamic authentication value should preferably be done in a secure cryptographic device, such as a host security module.

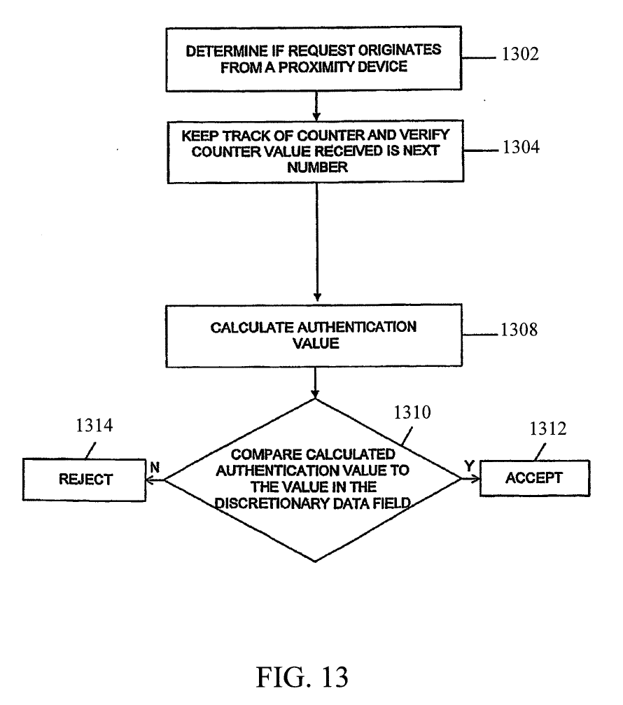

It will be appreciated by those skilled in the art that the methods of FIGS. 6-13 can be implemented on various standard computer platforms operating under the control of suitable software defined by FIGS. 6-13. In some cases, dedicated computer hardware, such as a peripheral card in a conventional personal computer, can enhance the operational efficiency of the above methods.

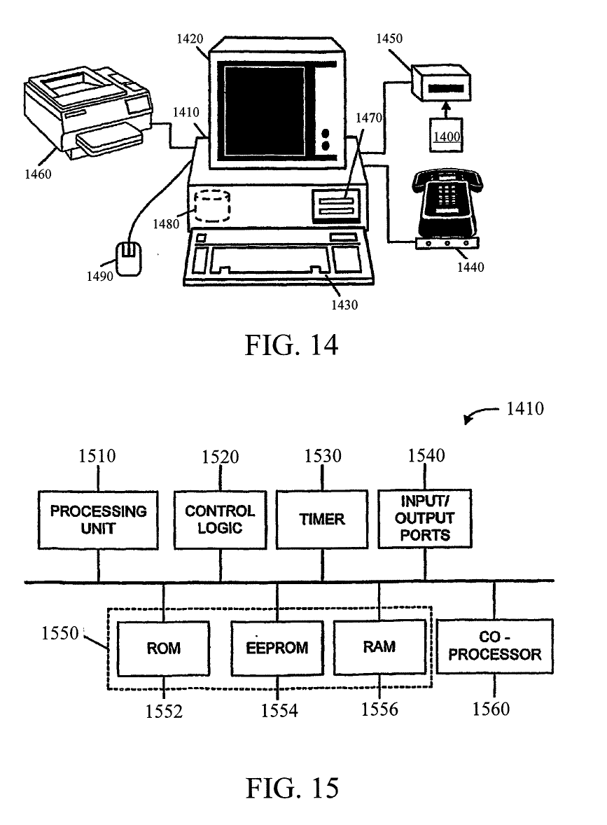

FIGS. 14 and 15 illustrate typical computer hardware suitable for performing the methods of the present invention. Referring to FIG. 14, the computer system includes a processing section 1410, a display 1420, a keyboard 1430, and a communications peripheral device 1440 such as a modem. The system typically includes a digital pointer 1490 such as a “mouse”, and can also include other input devices such as a card reader 1450 for reading an account card 1400. In addition, the system can include a printer 1460. The computer system typically includes a hard disk drive 1480 and one or more additional disk drives 1470 which can read and write to computer readable media such as magnetic media (e.g., diskettes or removable hard disks), or optical media (e.g., CD-ROMS or DVDs). The disk drives 1470 and 1480 are used for storing data and application software.

FIG. 15 is a functional block diagram which further illustrates the processing section 1410. The processing section 1410 generally includes a processing unit 1510, control logic 1520, and a memory unit 1550. Preferably, the processing section 1410 also includes a timer 1530 and input/output ports 1540. The processing section 1410 can also include a co-processor 1060, depending on the microprocessor used in the processing unit. Control logic 1520 provides, in conjunction with processing unit 1510, the control necessary to handle communications between memory unit 1550 and input/output ports 1540. Timer 1530 provides a timing reference signal for processing unit 1510 and control logic 1520. Co-processor 1560 provides an enhanced ability to perform complex computations in real time, such as those required by cryptographic algorithms.

Memory unit 1550 can include different types of memory, such as volatile and non-volatile memory and read-only and programmable memory. For example, as shown in FIG. 15, memory unit 1550 can include read-only memory (ROM) 1552, electrically erasable programmable read-only memory (EEPROM) 1554, and random-access memory (RAM) 1556. Various computer processors, memory configurations, data structures and the like can be used to practice the present invention, and the invention is not limited to a specific platform. The steps performed by the processing arrangement are not limited to specific hardware unless the claims so stipulate.

Software defined by FIGS. 6-13 can be written in a wide variety of programming languages, as will be appreciated by those skilled in the art.

The elements of the processing section 1410 can be included on a proximity chip 603. A coprocessor 1560 can be used to provide an enhanced ability to perform complex computations in real time, such as those required for DES and PKI encryption. The ROM 1552 preferably comprises a secure ROM which stores the first authentication key.

While there have been described what are believed to be preferred embodiments of the present invention, those skilled in the art will recognize that other and further changes and modifications may be made thereto without departing from the spirit of the invention, and it is intended to claim all such changes and modifications as fall within the true scope of the invention. For example, specific calculations for the dynamic authentication value have been shown for an embodiment with a Track 2 layout but the invention is also applicable to a Track 1 layout.

We claim:

1. A method of conducting a transaction using a proximity device, comprising:
receiving at a terminal a first authentication value from the proximity device, the first authentication value being dynamically generated by said device;
including the first authentication value in a discretionary data field of message data, the message data being arranged in an ISO format; and
transmitting the message data from said terminal for verification.

2. The method of claim 1, further comprising:
generating a random number;
transmitting an authentication command contactlessly from said terminal to said proximity device, the authentication command including said random number, the step of dynamically generating the first authentication value comprising using a first authentication key by the proximity device to derive the first authentication value from data comprising at least said random number;
calculating a second authentication value by an issuer using a second authentication key and said message data; and
comparing said second authentication value to said first authentication value by said issuer to verify the transaction.

3. The method of claim 1, wherein the message data is arranged in at least one of an ISO Track 1 format and an ISO Track 2 format.

4. The method of claim 2, further comprising entering user data into the terminal by a user, wherein the step of generating the random number is performed by the terminal based on the user data.

5. The method of claim 1, wherein the step of including the first authentication value in the discretionary data field of the message data is performed by said terminal.

6. The method of claim 1, wherein the step of including the first authentication value in the discretionary data field of the message data is performed by said proximity device.

7. The method of claim 1, wherein the step of including the first authentication value in the discretionary data field of the message data is performed by an agent of an issuer.

8. The method of claim 1, wherein said proximity device is in a form of a credit card.

9. The method of claim 8, wherein said proximity device includes a magnetic stripe.

10. The method of claim 9, wherein said proximity device includes a printed authentication value.

11. The method of claim 1, wherein said proximity device is in a form of a key fob.

12. The method of claim 1, wherein said proximity device is included in a mobile telephone.

13. The method of claim 1, wherein said proximity device is included in a watch.

14. The method of claim 2, further comprising:
ensuring by the terminal that said proximity device is an only proximity device within an operating field of said terminal before attempting a transaction.

15. The method of claim 1, further comprising:
detecting multiple proximity devices by the terminal in an operating field of the terminal;
prompting a user to select one of said multiple proximity devices.

16. The method of claim 2, wherein said data comprising at least said random number further comprises at least one of a proximity chip counter, a representation of the random number, and a representation of the proximity chip counter.

17. The method of claim 2, wherein the proximity device has a counter, the method further comprising increasing the counter by said proximity device after a time at which the proximity device is coupled to the terminal.

18. The method of claim 1, further comprising converting the message data to a binary coded decimal format by said terminal before the step of transmitting the message data from said terminal to said issuer.

19. The method of claim 1, wherein the proximity device includes a proximity chip.

20. The method of claim 2, wherein the second authentication key is equal to the first authentication key.

21. The method of claim 2, wherein the first authentication key is a public key infrastructure private key and the second authentication key is a public key infrastructure public key, wherein said public key infrastructure public key is associated with said public key infrastructure private key.

22. The method of claim 2, wherein said message data further includes at least one of a proximity chip counter, the random number, a representation of the random number, and a representation of the proximity chip counter.

23. The method of claim 22, further comprising comparing by said terminal said message data to at least one of the random number and a representation of the random number.

24. The method of claim 22, further comprising comparing by said issuer said message data to at least one of the random number and a representation of the random number.

25. The method of claim 2, wherein the step of generating the random number is performed by the terminal.

26. A system for conducting a transaction using a proximity device, comprising a processing arrangement configured to perform the steps of:
dynamically generating a first authentication value;
transmitting the first authentication value from the proximity device to a terminal;
including the first authentication value in a discretionary data field of message data, the message data being arranged in an ISO format; and
transmitting the message data from said terminal for verification.

27. A system according to claim 26, wherein the processing arrangement is further configured to perform the steps of:
generating a random number;
transmitting an authentication command contactlessly from said terminal to said proximity device, the authentication command including said random number, the step of dynamically generating the first authentication value comprising using a first authentication key by the proximity device to derive the first authentication value from data comprising at least said random number;
calculating a second authentication value by an issuer using a second authentication key and said message data; and
comparing said second authentication value to said first authentication value by said issuer to verify the transaction.

28. A system according to claim 26, wherein the message data is arranged in at least one of an ISO Track 1 format and an ISO Track 2 format.

29. A system according to claim 27, wherein the terminal is configured to receive user data from a user; the terminal being configured to perform the step of generating the random number based on the user data.

30. A system according to claim 26, wherein the terminal is configured to perform the step of including the first authentication value in the discretionary data field of the message data.

31. A system according to claim 26, wherein the proximity device is configured to perform the step of including the first authentication value in the discretionary data field of the message data.

32. A system according to claim 26, further comprising an agent of an issuer, the agent being configured to perform the step of including the first authentication value in the discretionary data field of the message data.

33. A system according to claim 26, wherein said proximity device is in a form of a credit card.

34. A system according to claim 33, wherein said proximity device includes a magnetic stripe.

35. A system according to claim 34, wherein said proximity device includes a printed authentication value.

36. A system according to claim 26, wherein said proximity device is in a form of a key fob.

37. A system according to claim 26, wherein said proximity device is included in a mobile telephone.

38. A system according to claim 26, wherein said proximity device is included in a watch.

39. A system according to claim 27, wherein the terminal is configured to perform the step of ensuring that said proximity device is an only proximity device within an operating field of said terminal before attempting a transaction.

40. A system according to claim 26, wherein the terminal is configured to perform the steps of:
detecting multiple proximity devices in an operating field of the terminal;
prompting a user to select one of said multiple proximity devices.

41. A system according to claim 27, wherein said data comprising at least said random number further comprises at least one of a proximity chip counter, a representation of the random number, and a representation of the proximity chip counter.

42. A system according to claim 27, wherein the proximity device has a counter, the proximity device is configured to perform the step of increasing the counter by said proximity device after a time at which the proximity device is coupled to the terminal.

43. A system according to claim 26, wherein the terminal is configured to perform the step of converting the message data to a binary coded decimal format before the step of transmitting the message data from said terminal to said issuer.

44. A system according to claim 26, wherein the proximity device includes a proximity chip.

45. A system according to claim 27, wherein the second authentication key is equal to the first authentication key.

46. A system according to claim 27, wherein the first authentication key is a public key infrastructure private key and the second authentication key is a public key infrastructure public key, wherein said public key infrastructure public key is associated with said public key infrastructure private key.

47. A system according to claim 27, wherein said message data further includes at least one of a proximity chip counter, the random number, a representation of the random number, and a representation of the proximity chip counter.

48. A system according to claim 47, wherein the terminal is configured to perform the step of comparing said message data to at least one of the random number and a representation of the random number.

49. A system according to claim 47, wherein the issuer is configured to perform the step of comparing said message data to at least one of the random number and a representation of the random number.

50. A system according to claim 27, wherein the terminal is configured to perform the step of generating the random number.

51. A computer-readable medium for conducting a transaction using a proximity device, the computer-readable medium having a set of instructions operable to direct a processor to perform the steps of:
dynamically generating a first authentication value;
transmitting the first authentication value from the proximity device to a terminal;
including the first authentication value in a discretionary data field of message data, the message data being arranged in an ISO format; and
transmitting the message data from said terminal for verification.

52. A computer-readable medium according to claim 51, wherein the set of instructions is further operable to direct the processor to perform the steps of:
generating a random number;
transmitting an authentication command contactlessly from said terminal to said proximity device, the authentication command including said random number, the step of dynamically generating the first authentication value comprising using a first authentication key by the proximity device to derive the first authentication value from data comprising at least said random number;
calculating a second authentication value by an issuer using a second authentication key and said message data; and
comparing said second authentication value to said first authentication value by said issuer to verify the transaction.

53. A computer-readable medium according to claim 51, wherein the message data is arranged in at least one of an ISO Track 1 format and an ISO Track 2 format.

54. A computer-readable medium according to claim 52, wherein the computer-readable medium is further operable to direct the terminal to receive user data from a user, the step of generating the random number being performed by the terminal based on the user data.

55. A computer-readable medium according to claim 51, wherein the step of including the first authentication value in the discretionary data field of the message data is performed by said terminal.

56. A computer-readable medium according to claim 51, wherein the step of including the first authentication value in the discretionary data field of the message data is performed by said proximity device.

57. A computer-readable medium according to claim 51, wherein the step of including the first authentication value in the discretionary data field of the message data is performed by an agent of an issuer.

58. A computer-readable medium according to claim 51, wherein said proximity device is in a form of a credit card.

59. A computer-readable medium according to claim 58, wherein said proximity device includes a magnetic stripe.

60. A computer-readable medium according to claim 59, wherein said proximity device includes a printed authentication value.

61. A computer-readable medium according to claim 51, wherein said proximity device is in a form of a key fob.

62. A computer-readable medium according to claim 51, wherein said proximity device is included in a mobile telephone.

63. A computer-readable medium according to claim 51, wherein said proximity device is included in a watch.

64. A computer-readable medium according to claim 51, wherein the set of instructions is further operable to direct the processor to perform the step of ensuring by the terminal that said proximity device is an only proximity device within an operating field of said terminal before attempting a transaction.

65. A computer-readable medium according to claim 52, wherein the set of instructions is further operable to direct the processor to perform the steps of:
detecting multiple proximity devices by the terminal in an operating field of the terminal;
prompting a user to select one of said multiple proximity devices.

66. A computer-readable medium according to claim 52, wherein said data comprising at least said random number further comprises at least one of a proximity chip counter, a representation of the random number, and a representation of the proximity chip counter.

67. A computer-readable medium according to claim 52, wherein the proximity device has a counter, the set of instructions is further operable to direct the processor to perform the step of increasing the counter by said proximity device after a time at which the proximity device is coupled to the terminal.

68. A computer-readable medium according to claim 51, wherein the set of instructions is further operable to direct the processor to perform the step of converting the message data to a binary coded decimal format by said terminal before the step of transmitting the message data from said terminal to said issuer.

69. A computer-readable medium according to claim 51, wherein the proximity device includes a proximity chip.

70. A computer-readable medium according to claim 52, wherein the second authentication key is equal to the first authentication key.

71. A computer-readable medium according to claim 52, wherein the first authentication key is a public key infrastructure private key and the second authentication key is a public key infrastructure public key, wherein said public key infrastructure public key is associated with said public key infrastructure private key.

72. A computer-readable medium according to claim 52, wherein said message data further includes at least one of a proximity chip counter, the random number, a representation of the random number, and a representation of the proximity chip counter.

73. A computer-readable medium according to claim 72, wherein the set of instructions is further operable to direct the terminal to perform the step of comparing said message data to at least one of the random number and a representation of the random number.

74. A computer-readable medium according to claim 72, wherein the set of instructions is further operable to direct an agent of the issuer to perform the step of comparing said message data to at least one of the random number and a representation of the random number.

75. A computer-readable medium according to claim 52, wherein the step of generating the random number is performed by the terminal.
